(19) United States
(12) Patent Application Publication
(10) Pub. No.: US 2025/0309545 A1
(43) Pub. Date: Oct. 2, 2025

(54) ELECTRONIC DEVICE

(71) Applicant: Lenovo (Beijing) Limited, Beijing (CN)

(72) Inventor: Shirong YANG, Beijing (CN)

(21) Appl. No.: 19/091,374

(22) Filed: Mar. 26, 2025

(30) Foreign Application Priority Data
Mar. 29, 2024 (CN) 202410384171.2

(51) Int. Cl. H01Q 13/08; H01Q 5/385

(52) U.S. Cl. CPC H01Q 13/08; H01Q 5/385

(57) ABSTRACT

Electronic device includes: a first antenna located at a first position and including a first parasitic structure and a first feeding structure, the first feeding structure including a first microstrip line structure, and the first antenna operating in a first frequency band; and a second antenna located at a second position and including a second parasitic structure and a second feeding structure, the second feeding structure including a second microstrip line structure and the second antenna operating in a second frequency band. The first position and the second position satisfy a target distance; and the first microstrip line structure is configured to suppress the first antenna from receiving radiation signals in the second frequency band, and the second microstrip line structure is configured to suppress the second antenna from receiving radiation signals in the first frequency band.

### CROSS REFERENCE TO RELATED APPLICATION

The present disclosure claims priority to Chinese Patent Application No. 202410384171.2, filed on Mar. 29, 2024, the entire content of which is incorporated herein by reference.

### TECHNICAL FIELD

The present disclosure is related to an electronic device.

### BACKGROUND

The increasing demand for data transmission rates in today's wireless communication and broadcasting environment has led to a growing number of antennas to be integrated into electronic devices. Typically, when laying out antennas, priority is given to keeping them separated. However, some antennas that need to operate in adjacent frequency bands are inevitably placed together. In such cases, interference between the antennas occurs, which reduces communication quality.

### SUMMARY

Embodiments of the present disclosure provide an electronic device. The electronic device includes: a first antenna located at a first position and including a first parasitic structure and a first feeding structure, the first feeding structure including a first microstrip line structure, and the first antenna operating in a first frequency band; and a second antenna located at a second position and including a second parasitic structure and a second feeding structure, the second feeding structure including a second microstrip line structure and the second antenna operating in a second frequency band. The first position and the second position satisfy a target distance; and the first microstrip line structure is configured to suppress the first antenna from receiving radiation signals in the second frequency band, and the second microstrip line structure is configured to suppress the second antenna from receiving radiation signals in the first frequency band.

### BRIEF DESCRIPTION OF THE DRAWINGS

FIG. 1 is a schematic diagram of an exemplary electronic device according to some embodiments of the present disclosure.

FIG. 2 is a schematic diagram of another exemplary electronic device according to some embodiments of the present disclosure.

FIG. 3 is a schematic diagram of another exemplary electronic device according to some embodiments of the present disclosure.

FIG. 4 is a schematic diagram of current distribution of an exemplary first antenna according to some embodiments of the present disclosure.

FIG. 5 is another schematic diagram of current distribution of an exemplary first antenna according to some embodiments of the present disclosure.

FIG. 6 is a schematic diagram of current distribution of an exemplary second antenna according to some embodiments of the present disclosure.

FIG. 7 is another schematic diagram of current distribution of an exemplary second antenna according to some embodiments of the present disclosure.

FIG. 8 is an exemplary equivalent circuit diagram according to some embodiments of the present disclosure.

### DETAILED DESCRIPTION OF THE EMBODIMENTS

It should be understood that the specific embodiments described herein are merely used to explain this present disclosure and are not intended to limit the scope of this disclosure.

At present, in some practical situations, when antennas are laid out in electronic devices, antennas operating in adjacent frequency bands are placed together. For example, a medium- and high-frequency antenna may be laid out near a Global Positioning System (GPS) antenna, or a high-frequency antenna may be laid out near a Bluetooth antenna. This situation can result in interference between adjacent antennas.

Based on the above-mentioned problem, the embodiment of this disclosure provides an electronic device and FIG. 1 is a schematic diagram of the component structure of an electronic device according to some embodiment of the present disclosure. As shown in FIG. 1, the electronic device 0 can include:
A first antenna 10, located at a first position, comprising a first parasitic structure 101 and a first feeding structure 102; the first feeding structure 102 includes a first microstrip line structure 1021; the first antenna 10 operates in a first frequency band;
A second antenna 11, located at a second position, comprising a second parasitic structure 111 and a second feeding structure 112; the second feeding structure 112 includes a second microstrip line structure 1121; the second antenna 11 operates in a second frequency band;

The first position and the second position satisfy a target distance, the first microstrip line structure 1021 is used to suppress the first antenna 10 from receiving radiation signals in the second frequency band, and the second microstrip line structure 1121 is used to suppress the second antenna 11 from receiving radiation signals in the first frequency band.

It should be noted that in the embodiment of this disclosure, the first antenna 10 operates in a first frequency band, and the second antenna 11 operates in a second frequency band. The first and second frequency bands are adjacent to each other. For example, the first frequency band could be a high-frequency band, Band 41 (2496-2690 MHZ), and the second frequency band could be a 2.4 GHz wireless communication technology (Wireless Fidelity, Wi-Fi) band (2400-2483 MHz), which is adjacent to Band 41. Similarly, the first frequency band could be the 2.4 GHz Wi-Fi band, and the second frequency band could be Band 41. The specific first and second frequency bands can be determined based on the actual situation, without limitation.

It should be noted that in the embodiment of this disclosure, as shown in FIG. 1, the first antenna 10 and the second antenna 11 are arranged adjacent to each other, and the distance between them satisfies target distance. The target distance is relatively small because, when the target distance is larger, even if the first antenna 10 and the second antenna 11 operate in adjacent frequency bands, the interference generated can be ignored.

It should be noted that in the embodiment of this disclosure, since the first antenna 10 and the second antenna 11 operate in adjacent frequency bands, the first antenna 10 and the second antenna 11 are arranged adjacent to each other, and the first antenna 10 and the second antenna 11 are reciprocal antennas, when the first antenna 10 operates in the first frequency band, part of the signal generated based on the first frequency band will leak into the second antenna 11. The second antenna 11 will receive the signal generated based on the first frequency band leaked from the first antenna 10 while operating based on the second frequency band, thereby affecting the radiation performance of the second antenna 11. Similarly, when the second antenna 11 operates in the second frequency band, part of the signal generated based on the second frequency band will leak into the first antenna 10. The first antenna 10 will receive the signal generated based on the second frequency band leaked from the second antenna 11 while operating based on the first frequency band, thereby affecting the radiation performance of the first antenna 10. Based on this, the present disclosure adds a first microstrip line structure 1021 in the first feeding structure 102 of the first antenna 10 to shield the signal generated based on the second frequency band that is leaked from the second antenna 11 to the first antenna 10, and at the same time adds a second microstrip line structure 1121 in the second feeding structure 112 of the second antenna 11 to shield the signal generated based on the first frequency band that is leaked from the first antenna 10 to the second antenna 11.

It can be understood that the first microstrip line structure 1021 in the first antenna 10 is used to generate a non-radiative resonance corresponding to the second frequency band, and based on the notch effect of the non-radiative resonance, the signal generated based on the second frequency band that is leaked from the second antenna 11 to the first antenna 10 is shielded; the second microstrip line structure 1121 in the second antenna 11 is used to generate a non-radiative resonance corresponding to the first frequency band, and based on the notch effect of the non-radiative resonance, the signal generated based on the first frequency band that is leaked from the first antenna 10 to the second antenna 11 is shielded, thereby reducing the interference between the first antenna 10 and the second antenna 11, thereby improving the radiation performance of the first antenna 10 and the second antenna 11, and improving the communication quality.

In one embodiment of the present disclosure, the first feeding structure 102 further includes a first feeding section 1022, and the second feeding structure 112 further includes a second feeding section 1122. The first feeding section 1022 and the second feeding section 1122 are L-shaped.

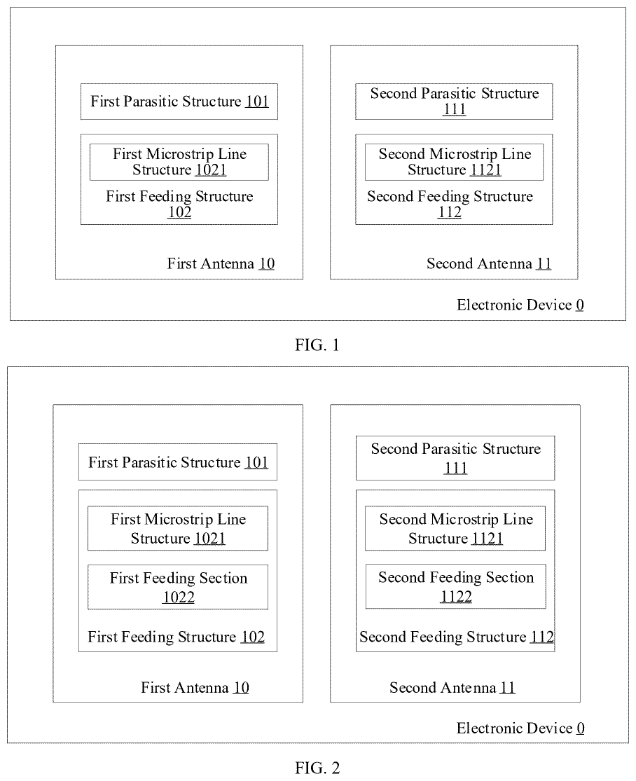

It should be noted that in the embodiment of the present disclosure, as shown in FIG. 2, the first feeding structure 102 includes a first microstrip line structure 1021 and a first feeding section 1022, and the second feeding structure 112 includes a second microstrip line structure 1121 and a second feeding section 1122. At the same time, the first feeding section 1022 and the second feeding section 1122 are L-shaped.

In one embodiment of the present disclosure, the first microstrip line structure 1021 is formed with at least three branches through bending, with at least two branches overlapping in a first target direction. The first target direction is the direction toward the first feeding structure 102. The second microstrip line structure 1121 is formed with at least three branches through bending, with at least two branches overlapping in a second target direction. The second target direction is the direction toward the second feeding structure 112.

It should be noted that in the embodiment of the present disclosure, two branches in the first microstrip line structure 1021 have overlapping projection in the first target direction, where the first target direction is the direction toward the first feeding structure 102. For example, two branches of the first microstrip line structure 1021 have overlapping projection in the direction towards the first feeding structure 102. Similarly, two branches in the second microstrip line structure 1121 have overlapping projection in the second target direction, where the second target direction is the direction toward the second feeding structure 112. For example, two branches of the second microstrip line structure 1121 have overlapping projection in the direction towards the second feeding structure 112. Designing the microstrip line structure in a bent shape not only saves space when laying out antennas, but also improves the shielding performance of the microstrip line structure.

In one embodiment of the present disclosure, the first parasitic structure 101 and the second parasitic structure 111 are L-shaped.

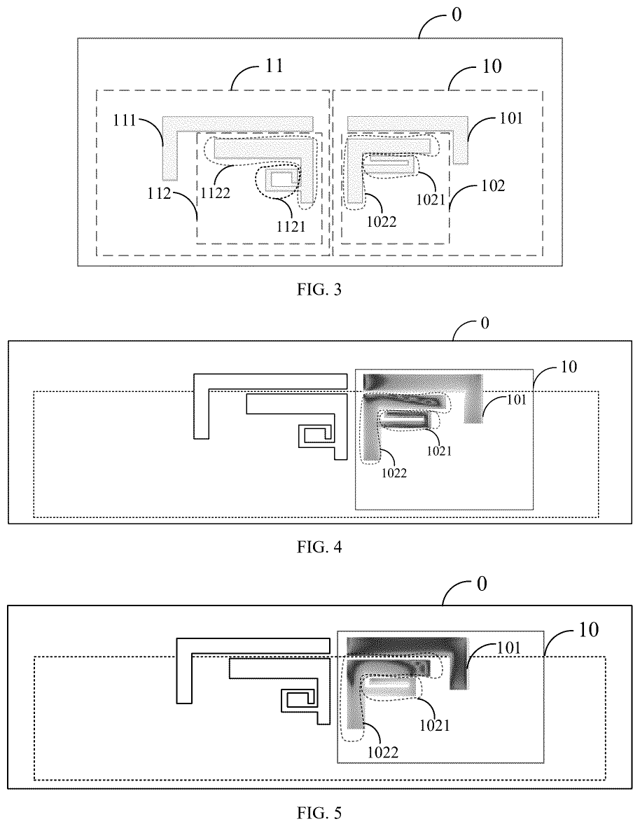

As shown in FIG. 3, the first antenna 10 includes two parts: a first parasitic structure 101, which is in an L-shape, and a first feeding structure 102. The first feeding structure 102 includes a bent first microstrip line structure 1021 and an L-shaped first feeding part 1022. Similarly, the second antenna 11 also includes two parts: a second parasitic structure 111, which is in an L-shape, and a second feeding structure 112. The second feeding structure 112 includes a bent second microstrip line structure 1121 and an L-shaped second feeding part 1122. It can be understood that this is just an example of an electronic device 0 presented in the embodiment of the present disclosure. In actual situations, the electronic device 0 is not limited to the component structure shown in FIG. 3.

In one embodiment of the present disclosure, the material of the first microstrip line structure 1021 and the second microstrip line structure 1121 is a metal with a dielectric constant greater than a preset value.

It should be noted that in the embodiment of the present disclosure, the first antenna 10 and the second antenna 11 are in a coupled feeding form. For example, the first parasitic structure 101 and the first feeding structure 102 in the first antenna 10 conduct electrical energy through coupling, and the second parasitic structure 111 and the second feeding structure 112 in the second antenna 11 conduct electrical energy through coupling. At the same time, to achieve better radiation effect, the first parasitic structure 101 and the second parasitic structure 111 are metal strips, and the first microstrip line structure 1021 in the first feeding structure 102 and the second microstrip line structure 1121 in the second feeding structure 112 are metal materials with high dielectric constants. The specific material can be determined based on actual situation, without limitations.

In one embodiment of the present disclosure, the length of the first microstrip line structure 1021 is determined based on the second frequency band, and the length of the second microstrip line structure 1121 is determined based on the first frequency band.

It should be noted that in the embodiment of the present disclosure, assuming that the first microstrip line structure 1021 in the first antenna 10 includes three branches as shown in FIG. 3, and that the first microstrip line structure 1021 is used to shield the signal generated in the second frequency band and leaked from the second antenna 11 into the first antenna 10, the total length of the three branches of the first microstrip line structure 1021 is determined based on the second frequency band. Similarly, assuming that the second microstrip line structure 1121 in the second antenna 11 includes four branches as shown in FIG. 3, and that the second microstrip line structure 1121 is used to shield the signal generated in the first frequency band and leaked from the first antenna 10 into the second antenna 11, the total length of the four branches of the second microstrip line structure 1121 is determined based on the first frequency band. Moreover, the length of the microstrip line structure is inversely proportional to the frequency of the frequency band, that is, the higher the frequency of the frequency band, the shorter the length of the corresponding microstrip line structure is, and the lower the frequency of the frequency band, the higher the length of the corresponding microstrip line structure is. In the embodiment of the present disclosure, the first antenna 10 operates in the first frequency band, Band 41, with a frequency range of 2496-2690 MHz, and the second antenna 11 operates in the second frequency band, the 2.4 GHz Wi-Fi band, with a frequency range of 2400-2483 MHz. It can be observed that the frequency of the first frequency band is greater than that of the second frequency band. Therefore, the total length of the second microstrip line structure 1121, which is set according to the first frequency band, is greater than the total length of the first microstrip line structure 1021, which is set according to the second frequency band. The specific length of the microstrip line structure can be determined based on actual situation, without limitations.

In one embodiment of the present disclosure, the first parasitic structure 101 and the first feeding structure 102 correspond to the first antenna clearance region, the first microstrip line structure 1021 corresponds to the second antenna clearance region, the second parasitic structure 111 and the second feeding structure 112 correspond to the third antenna clearance region, and the second microstrip line structure 1121 corresponds to the fourth antenna clearance region.

It can be understood that placing the antenna in a antenna clearance region can improve the antenna's radiation efficiency and increase its gain performance. Therefore, in the present disclosure, both the first antenna 10 and the second antenna 11 are placed in the antenna clearance regions, aiming to further enhance the communication quality of the antennas.

It should be noted that in the embodiment of the present disclosure, in actual situations, if the antenna clearance region in the electronic device 0 is limited, the first parasitic structure 101 and the second parasitic structure 111 can be the only items placed in the limited antenna clearance region. Since the radiation of the antenna is carried out through the parasitic structure, when the antenna clearance region is limited, the radiation performance of the antenna can be guaranteed by preferentially setting the parasitic structure in the antenna clearance region.

In one embodiment of the present disclosure, the first microstrip line structure 1021 is located within the first area formed by the first feeding structure 102, and the second microstrip line structure 1121 is located within the second area formed by the second feeding structure 112.

It should be noted that in the embodiment of the present disclosure, as shown in FIG. 3, the first microstrip line structure 1021 is arranged in the first area of the first feeding structure 102, the first feeding section 1022 is also arranged in the first area of the first feeding structure 102, and the first microstrip line structure 1021 and the first feeding section 1022 have a contact point. Similarly, the second microstrip line structure 1121 is arranged in the second area of the second feeding structure 112, the second feeding section 1122 is also arranged in the second area of the second feeding structure 112, and the second microstrip line structure 1121 and the second feeding section 1122 have a contact point.

In one embodiment of the present disclosure, if the first antenna 10 operates in the second frequency band, the first microstrip line structure 1021 of the first antenna 10 can generate resonance at the second frequency band without radiating the resonance of the second frequency band. Similarly, if the second antenna 11 operates in the first frequency band, the second microstrip line structure 1121 of the second antenna 11 can generate resonance at the first frequency band without radiating the resonance of the first frequency band.

As an example, as shown in FIG. 4, which is a schematic diagram of the current distribution of the first antenna 10 when operating in the first frequency band, areas with lighter colors indicate locations where the current is concentrated. The more concentrated the current, the better the radiation efficiency is at that point. It can be seen that in FIG. 4, the color of the first parasitic structure 101 is lighter, indicating that when the first antenna 10 operates in the first frequency band, the current is mainly concentrated on the first parasitic structure 101 of the first antenna 10, and the radiation efficiency at the first parasitic structure 101 is better. At the same time, the color of the first microstrip line structure 1021 is darker, indicating that when the first antenna 10 operates in the first frequency band, the current at the first microstrip line structure 1021 is very small, and the radiation efficiency at the first microstrip line structure 1021 is poor. Further, since the antenna radiates through the parasitic structure during the radiation process, it is shown that the first antenna 10 has good radiation efficiency when operating in the first frequency band. Furthermore, as shown in FIG. 5, which is a schematic diagram of the current distribution of the first antenna 10 when operating in the second frequency band, the first microstrip line structure 1021 has a lighter color, indicating that when the first antenna 10 operates in the second frequency band, the current is mainly concentrated on the first microstrip line structure 1021 of the first antenna 10, that is, the first microstrip line structure 1021 generates non-radiative resonance based on the second frequency band; the first parasitic structure 1011 has a darker color, indicating that when the first antenna 10 operates in the second frequency band, the current on the first parasitic structure 101 is very small, that is, the radiation efficiency of the first antenna 10 when working in the second frequency band is poor, and as a result, the interference to the second antenna 11 is small.

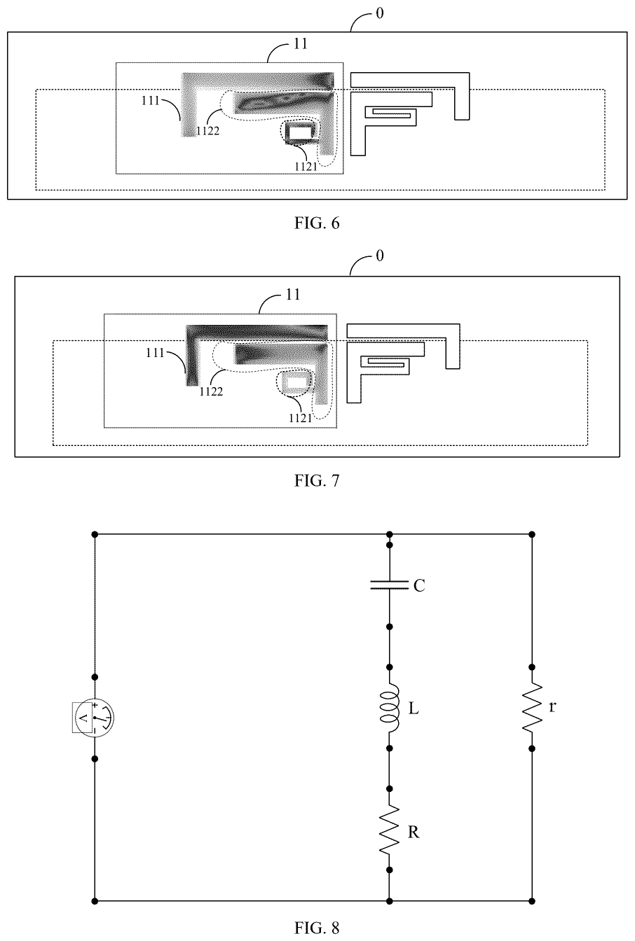

As an example, as shown in FIG. 6, which is a schematic diagram of the current distribution of the second antenna 11 when operating in the second frequency band, areas with lighter colors indicate locations where the current is concentrated. The more concentrated the current, the better the radiation efficiency is at that point. It can be seen that in FIG. 6, the color of the second parasitic structure 111 is lighter, indicating that when the second antenna 11 operates in the second frequency band, the current is mainly concentrated on the second parasitic structure 111 of the second antenna 11, and the radiation efficiency at the second parasitic structure 111 is better. At the same time, the color of the second microstrip line structure 1121 is darker, indicating that when the second antenna 11 operates in the second frequency band, the current at the second microstrip line structure 1121 is very small, and the radiation efficiency at the second microstrip line structure 1121 is poor. Further, since the antenna radiates through the parasitic structure during the radiation process, it is shown that the second antenna 11 has good radiation efficiency when operating in the second first frequency band. Furthermore, as shown in FIG. 7, which is a schematic diagram of the current distribution of the second antenna 11 when operating in the first frequency band, the second microstrip line structure 1121 has a lighter color, indicating that when the second antenna 11 operates in the first frequency band, the current is mainly concentrated on the second microstrip line structure 1121 of the second antenna 11, that is, the second microstrip line structure 1121 generates non-radiative resonance based on the first frequency band; the second parasitic structure 1111 has a darker color, indicating that when the second antenna 11 operates in the first frequency band, the current on the second parasitic structure 111 is very small, that is, the radiation efficiency of the second antenna 11 when working in the first frequency band is poor, and as a result, the interference to the first antenna 10 is small.

Furthermore, in FIG. 4 to FIG. 7, the space outside the dotted box is the antenna clearance region. It can be seen that when the antenna clearance region is limited, the radiation performance of the antenna can be guaranteed by preferentially setting the parasitic structure in the antenna clearance region.

In one embodiment of the present disclosure, the radiation efficiency of the first parasitic structure 101 and the first feeding structure 102 is better than the radiation efficiency of the first microstrip line structure 1021; the radiation efficiency of the second parasitic structure 111 and the second feeding structure 112 is better than the radiation efficiency of the second microstrip line structure 1121.

It should be noted that in the embodiment of the present disclosure, the first microstrip line structure 1021 generates a non-radiative resonance, which essentially does not radiate energy and is only used to shield signals leaked from the second frequency band to the first antenna 10. Its radiation efficiency is very low, typically around 2% to 3%, while the radiation efficiency of the first parasitic structure 101 and the first feeding structure 102 when operating in the first frequency band is usually above 50%. Similarly, the second microstrip line structure 1121 generates a non-radiative resonance, which essentially does not radiate energy and is only used to shield signals leaked from the first frequency band to the second antenna 11. Its radiation efficiency is very low, typically around 2% to 3%, while the radiation efficiency of the second parasitic structure 111 and the second feeding structure 112 when operating in the second frequency band is usually above 50%.

As an example, as shown in FIG. 8, which is an equivalent circuit diagram of a first antenna 10/second antenna 11, the resistor “r” on the far right is equivalent to the radiation resistance of the first antenna 10/second antenna 11, and the RLC resonant circuit composed of a resistor R, an inductor L and a capacitor C in the middle is equivalent to the first microstrip line structure 1021/second microstrip line structure 1121 in the first antenna 10/second antenna 11. The RLC resonant circuit can generate resonance, but this resonance is a non-radiative resonance, does not radiate energy to the outside, and is only used to shield signals of some specific wavelengths.

The present disclosure provides an electronic device, which includes a first antenna, located at a first position, comprising a first parasitic structure and a first feeding structure; the first feeding structure includes a first microstrip line structure; the first antenna operates in a first frequency band; a second antenna, located at a second position, comprising a second parasitic structure and a second feeding structure; the second feeding structure includes a second microstrip line structure; the second antenna operates in a second frequency band; The first position and the second position satisfy a target distance; the first microstrip line structure is used to suppress the first antenna from receiving radiation signals in the second frequency band, and the second microstrip line structure is used to suppress the second antenna from receiving radiation signals in the first frequency band. Based on the above, the first microstrip line structure in the first antenna is used to generate a non-radiative resonance corresponding to the second frequency band, and then based on the notch effect of the non-radiative resonance, the signal generated based on the second frequency band that is leaked from the second antenna to the first antenna is shielded; the second microstrip line structure in the second antenna is used to generate a non-radiative resonance corresponding to the first frequency band, and then based on the notch effect of the non-radiative resonance, the signal generated based on the first frequency band that is leaked from the first antenna to the second antenna is shielded, thereby reducing the interference between the first antenna and the second antenna, thereby improving the radiation performance of the first antenna and the second antenna, and improving the communication quality.

It should be noted that, in the present disclosure, terms “include,” “comprises” or any other variations thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the sentence “comprises a . . . ” does not exclude the existence of other identical elements in the process, method, article or device.

The above is only a specific embodiment of the present disclosure, but the protection scope of the present disclosure is not limited thereto. Any changes or substitutions that can be easily thought of by a person skilled in the art within the technical scope disclosed in the present disclosure should be included in the protection scope of the present disclosure. Therefore, the protection scope of the present disclosure shall be based on the protection scope of the claims.

What is claimed is:

1. An electronic device, comprising:
a first antenna, located at a first position and comprising a first parasitic structure and a first feeding structure, the first feeding structure including a first microstrip line structure and the first antenna operating in a first frequency band; and
a second antenna, located at a second position and comprising a second parasitic structure and a second feeding structure, the second feeding structure including a second microstrip line structure and the second antenna operating in a second frequency band; wherein
the first position and the second position satisfy a target distance; and
the first microstrip line structure is configured to suppress the first antenna from receiving radiation signals in the second frequency band, and the second microstrip line structure is configured to suppress the second antenna from receiving radiation signals in the first frequency band.

2. The electronic device according to claim 1, wherein:
in response to the first antenna operating in the second frequency band, the first microstrip line structure of the first antenna is able to generate resonance of the second frequency band without radiating the resonance of the second frequency band; and
in response to the second antenna operating in the first frequency band, the second microstrip line structure of the second antenna is able to generate resonance at the first frequency band without radiating the resonance of the first frequency band.

3. The electronic device according to claim 1, wherein:
a radiation efficiency of the first parasitic structure and the first feeding structure is better than a radiation efficiency of the first microstrip line structure; and
a radiation efficiency of the second parasitic structure and the second feeding structure is better than a radiation efficiency of the second microstrip line structure.

4. The electronic device according to claim 3, wherein:
the first parasitic structure and the first feeding structure correspond to a first antenna clearance region, and the first microstrip line structure corresponds to a second antenna clearance region, and
the second parasitic structure and the second feeding structure correspond to a third antenna clearance region, and the second microstrip line structure corresponds to a fourth antenna clearance region.

5. The electronic device according to claim 3, wherein:
the first microstrip line structure is located within a first area formed by the first feeding structure; and
the second microstrip line structure is located within a second area formed by the second feeding structure.

6. The electronic device according to claim 4, wherein:
the first microstrip line structure is bent to form at least three branches, two branches of the at least three branches overlapping in a first target direction, and the first target direction being a direction toward the first feeding structure; and
the second microstrip line structure is bent to form at least three branches, two branches of the at least three branches overlapping in a second target direction, and the second target direction being a direction toward the second feeding structure.

7. The electronic device according to claim 5, wherein:
the first microstrip line structure is bent to form at least three branches, two branches of the at least three branches overlapping in a first target direction, and the first target direction being a direction toward the first feeding structure; and
the second microstrip line structure is bent to form at least three branches, two branches of the at least three branches overlapping in a second target direction, and the second target direction being a direction toward the second feeding structure.

8. The electronic device according to claim 1, wherein:
each of the first microstrip line structure and the second microstrip line structure is made of a material including a metal having a dielectric constant greater than a preset value.

9. The electronic device according to claim 1, wherein:
a length of the first microstrip line structure is determined based on the second frequency band; and
a length of the second microstrip line structure is determined based on the first frequency band.

10. The electronic device according to claim 1, wherein:
each of the first parasitic structure and the second parasitic structure is L-shaped.

11. The electronic device according to claim 5, wherein:
the first feeding structure further includes a first feeding section, and
the second feeding structure further includes a second feeding section; and
the first feeding section and the second feeding section are L-shaped.

12. The electronic device according to claim 11, wherein:
the first feeding section is also arranged in the first area of the first feeding structure, and
the first microstrip line structure and the first feeding section have a contact point.

13. The electronic device according to claim 11, wherein:
the second feeding section is also arranged in the second area of the second feeding structure, and
the second microstrip line structure and the second feeding section have a contact point.

14. The electronic device according to claim 1, wherein:
the first antenna includes a coupled feeding form, and
the second antenna includes a coupled feeding form.

15. The electronic device according to claim 1, wherein:
in response to a antenna clearance region in the electronic device being limited, only the first parasitic structure and the second parasitic structure are placed in the antenna clearance region.
